(19) United States
(12) Patent Application Publication
(10) Pub. No.: US 2014/0129505 A1
(43) Pub. Date: May 8, 2014

(54) SOCIAL EVENT RECOMMENDATION SYSTEM

(71) Applicant: MICROSOFT CORPORATION, Redmond, WA (US)

(72) Inventors: Jyh-Han Lin, Mercer Island, WA (US); Adam Dyba, Redmond, WA (US); Qiang Wu, Sammamish, WA (US)

(73) Assignee: Microsoft Corporation, Redmond, WA (US)

(21) Appl. No.: 13/672,551

(22) Filed: Nov. 8, 2012

(51) Int. Cl. G06N 5/02

(52) U.S. Cl. CPC G06N 5/02
USPC 706/50

(57) ABSTRACT

A system for recommending social events includes a front-end interface for establishing communication over a communications network and a user database module for accessing a plurality of user profiles. An activities database module is provided for accessing a plurality of activities that users may attend. The system also includes a recommendation engine operable in at least a first user-selectable mode. The first user-selectable mode provides at least one recommendation. Each of the recommendations includes a plurality of invitees and at least one activity to be attended by the plurality of invitees. The invitees are selected from a set of invitees accessible through the user database module and the activity is selected from a set of activities accessible through the activities database module. In one mode of operation, the invitees and the activity are both selected by the system and are not preselected by the user.

### BACKGROUND

Before significant technological advancements, newsletters and bulletin boards were used to notify people, groups, committees, clubs, societies and organizations about upcoming events, programs, new members and other relevant information. Through recent technological advancements, including the Internet, intranets, email, and mobile communication devices, newer and more advanced forms of communication have become available for trying to keep large groups of people informed about common interests. One such avenue has been online social networking websites which connect people through chat rooms and personal profiles.

Another technological advancement that has become popular through the Internet has been the process of inviting people to an event or meeting. Through different mediums (e.g., a website, an email or another software product), individuals can electronically invite already-identified people to a specified event or meeting. This existing technology allows users to view information about the people who will be attending the event and information about people who have declined to attend. While these technologies offer an alternative to paper invitations, they are limited to inviting only people who are already known to the person initiating the event or meeting.

All these factors, among others, make the existing social interaction technology less than ideal to facilitate the scheduling of an activity with two or more people, unknown to each other, who have geographic similarities and a desire to participate in an activity they both enjoy.

### SUMMARY

A system and method is provided for making recommendations for social events. In recommending social events two key questions generally arise: what activities are to be recommended and who is to be invited. The system can address this problem in any of three ways: (1) given a social group of individuals, the system can suggest activities; (2) given a set of activities, the system can suggest individuals and/or a pre-established social group; (3) given neither a set of activities or a set of invitees, the system can suggest both the activities and the invitees and/or a pre-established social group. In some implementations the first two approaches can be performed incrementally by adding or removing invites or activities. Moreover, in some cases the system can operate in a multi-modal manner in which the user begins with approach (3), for example, and then tinker (i.e., add or/or remove) with both the invites and the activities.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an overview of a framework illustrating various sources of input data that may be provided to schedule social events.

FIG. 2 shows an illustrative computing environment which facilitates interaction between users and an event recommendation system through, in one implementation, a client device with a network connection to a social network system.

FIG. 3 shows a functional block diagram of one example of a social networking system that includes an event recommendation system in more detail.

FIG. 4 shows one example of a screen shot of a web page that may be presented to a user through the user interface of the event recommendation system.

FIG. 5 shows a web page that may be presented to the user upon selecting the profile navigation tag shown in FIG. 4.

FIG. 6 shows a web page that may be presented to the user upon selecting the recommendations tag shown in FIG. 4.

### DETAILED DESCRIPTION

The detailed description herein is presented for purposes of illustration only and is not to be construed as a limitation on the subject matter described herein. For example, the steps recited in any of the method or process descriptions may be executed in any order and are not limited to the order presented. Furthermore, any reference to singular includes plural embodiments, and any reference to more than one component may include a singular embodiment. For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one implementation, the invention includes a system and method for scheduling social events through the use of social networks. As used herein, “social network” or similar phrases may include any grouping of two or more individuals through shared (or different) geographic regions, interests, hobbies, sporting interests, relationship status, race or religious interests, political interests, and the like. The invention thus includes the facilitation of electronic communication over the Internet or other networking protocol for the purpose of scheduling social events.

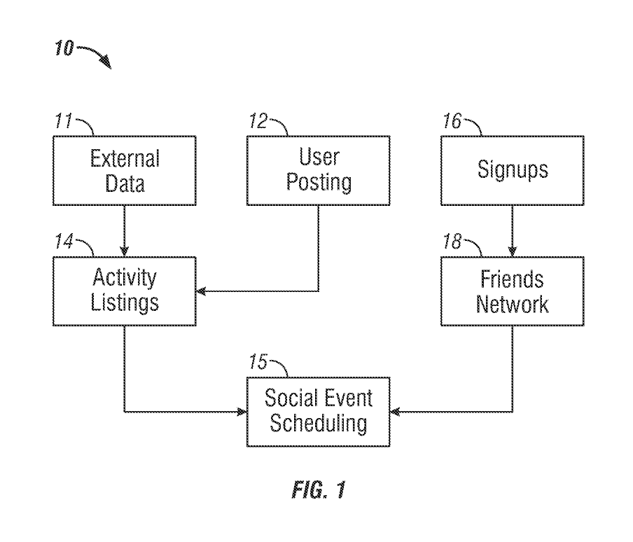

FIG. 1 is an overview of a framework illustrating various sources of input data that may be provided to recommend social events. Activity listings 14 include activity data that can come from external data feeds 11 or postings from users 12. Event types can include concerts, live music, arts and cultural events, social and community events, sporting events, outdoor activities and other recreational activities, professional and business events, and private parties and gatherings. The external data feed 11 may provide a much bigger selection of events overall than those input by the users alone. There are sources that make event listings available as RSS or XML feeds, which are structured data feeds that can be easily parsed by a computer program. In addition, some web sites have unstructured event listings that are designed for display by a web browser, and thus are put into a usable format. Event details, such as event name, time and venue, can be extracted from unstructured text or HTML and duplicate events that appear in multiple sources be removed.

The friends' network 18 provides information concerning individuals who may be candidate invitees to participate in various activities that make up a social event. The friends' network 18 may include data available from user profiles, which may provide information concerning users' locations, calendars and the like. The friends' network 18 provides a means for people to describe themselves in a detailed user profile, specify their friends, find friends' friends, browse profiles, invite more of their friends to join and fill out their profiles, messaging and communication, create groups and identify others of interest. The friends' network 18 may be populated from a variety of sources, including a user's social network or networks. In addition, friends may sign-up 16 to join the friends' network 18 for purposes of being invited to social events and may also check-in for various events.

The social event scheduling 15 provides functionality to plan and coordinate social events using the information obtained from the input data sources discussed above. In particular, social event scheduling is used to identify people interested in the same activity, determine availability, send electronic invitations and social calendaring, and after the completion of the events, obtain feedback from participants, which can be used in scheduling future events.

The framework described above can be used to manage and coordinate a user's social events. One example of a system that implements this framework will be presented below.

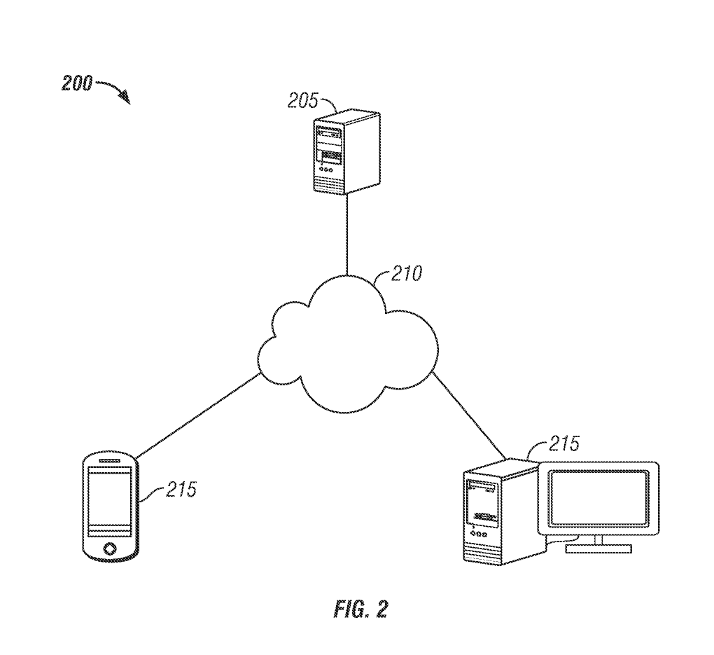

FIG. 2 shows an illustrative computing environment 200 which facilitates interaction between users and an event recommendation system through, in one implementation, a client device with a network connection to a social network system 205. Social network system 205 can be implemented using a single computing device or multiple computing devices, which can be co-located or distributed across two or more locations. For instance, in some implementations, system 205 can be implemented using one or more application servers, web servers, and/or data servers.

Social networking system 205 can be adapted to communicate with subscribing users over a network 210, which can be implemented using one or more data networks. For instance, network 210 can include either of both of wired and wireless communication links. Further, network 210 can be a public network, e.g. the Internet, a private network, e.g. a cellular data network, or a combination thereof. Network 210 also can include one or more gateways, which facilitate the transfer of data between devices using different protocols. Network 210 also can include either or both of secure links and unsecure links. Additionally, network 210 can include network infrastructure provided by multiple parties, such as a host network and one or more partner networks, e.g. roaming partners.

One or more client devices 215 associated with subscribing users also can be configured to communicate over network 210, e.g. with social networking system 205. Any number of client devices 215 can be included in computing environment 200. As the number of mobile communications devices 215 increases, system 205 and network 210 can be scaled, e.g. by adding additional resources, to provide an acceptable level of service. For purposes of illustration only, FIG. 1 shows two client devices 215. Client devices 215 may be any devices that can communicate over network 210. For example, client devices 215 may be, without limitation, a PC, laptop, netbook, tablet, television, gaming device, landline or wireless telephone, smart phone, media device or a dedicated appliance.

If client devices 215 are mobile communications devices such as wireless phones, in some cases they may also contain other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application.

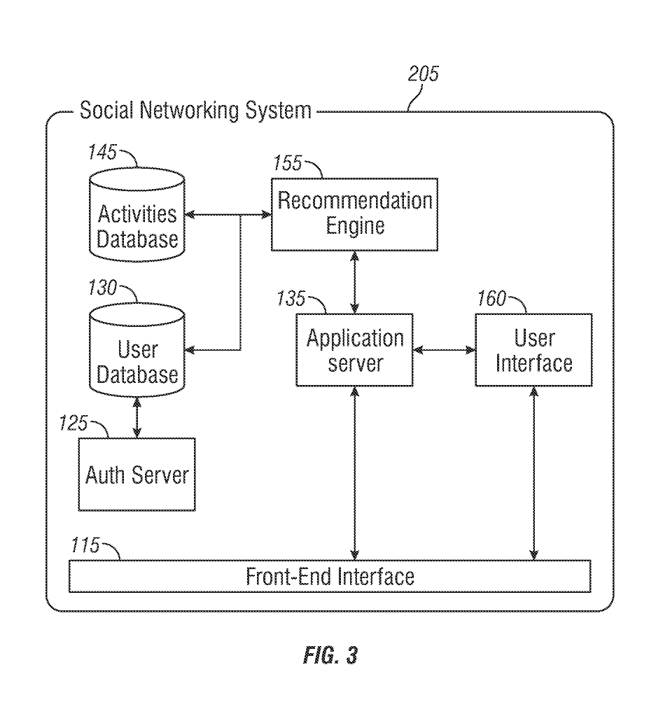

FIG. 3 shows a functional block diagram of one example of a social networking system 205 in more detail. In this example the social networking system 205 includes the functionality performed by the event recommendation system. In other embodiments, however, these functions may be performed by separate entities that communicate over a network such as network 210 in FIG. 2. That is, the event recommendation system may interact with a variety of social networks such as Facebook, Twitter, Flickr, Digg, Foursquare and Linkedin, for example. The social networking system 205 includes front-end interface 115, authentication server 125, activities database 145, application server 135, user database 130 and recommendation engine 155.

Social networking system 205 may employ the authentication server 125 in order to validate and assign proper permissions to authorized users of the social networking system 205. The social networking system 205 may be employed to manage various applications, modules and utilities that are utilized by social networking system 205. The front-end interface 115, which may comprise a set of APIs, for example, is used to establish communication with client devices over a communications network.

Activities database 145 may include information on popular activities chosen by other users who subscribe to the system, thus facilitating appropriate choices for activities that would interest significant numbers of users. By way of illustration, the activities can include, for instance, professional conferences, movies, concerts, local events (e.g., music and sporting events, fairs, parades, family events, etc.), theater, sports, extension classes (at local universities or through online-courses), cooking classes, dining, food delivery, hiking trips, and so on, to name a few.

The activities database 145, which may be, for instance, centralized, distributed or federated, may also receive activities information from multiple sources such as event promoters, local newspapers, movie listings, restaurants, enterprise sources, other search engines or recommendation systems etc. In a more specific implementation, the activities can be received from a dedicated server or multiple servers that are disposed on a network to provide this kind of activity information. The server(s) function as a consolidation point for disseminating activity information to other destinations such as client applications and/or other server applications. Access to the server(s) can be allowed by subscription, for example, or provided as a result of simply installing the client and/or server application that facilitate the capability of the disclosed architecture. More specifically, the end-user (e.g., client, server) can subscribe to obtain the activity information. Additionally, entities (e.g., vendors) can subscribe for the opportunity to push selected activity information to the end-users via the server(s).

The user database 130, which may be, for instance, centralized, distributed or federated, stores the user profiles of the various users who participate in the social networking system. The user profiles may include biographic, demographic, and other types of descriptive information, such as work experience, educational history, hobbies or preferences, interests, location, and the like. Demographic data typically includes data about the user, such as age, gender, location, etc. Behavioral data typically includes information about the user's activities within the social networking system, such as specific actions (posts, likes, comments, etc.), activity levels, usage statistics, etc. Other social data comprises information about the user from within the social networking system that is not strictly demographic or behavioral, such as interests or affinities, etc. In one embodiment, user's interests may be explicitly specified in the user's profile or they may be inferred from the user's activities in the social networking system (e.g., uploaded content, postings, reading of messages, etc). The user profile may also include a wish list of events they like, favorite venues and artists, as well as categories of events they like. The user database 130 may include groups of individuals (e.g., families, clubs) as the basic building blocks upon which recommendations may be based.

The user database 130 may contain data structures with fields suitable for defining the user profile, including data structures suitable for describing the user's demographic data, behavioral data, and other social data. Additionally, the user profile store 240 may include logic for maintaining user interest information according to one or more categories. Categories may be general or specific, e.g., if a user “likes” an article about a brand of shoes the category may be the brand, or the general category of “shoes” or “clothing.” Multiple categories may apply to a single user interest.

In one embodiment, recommendation engine 155 is invoked by application server 135 to query the user database 130 and/or the activities database 145 to retrieve data relating to other users, scheduled events, activities, venues, locations, facilities, and the like. In addition, recommendation engine 155 may be used for the purposes of, for example, retrieving activities information, retrieving calendar entries, retrieving advertising information, creating invitations to events, creating announcements, saving event information, maintaining participant data, processing payments, and the like.

In addition, recommendation engine 155 uses the information in the user database 130 and the activities database 145 to recommend social events upon the request of a user who is organizing the social event. The recommendation engine 155 may also make recommendations based on a variety of additional information including, for instance, a history of previously attended events, including user feedback about those previously attended events and profiles of a particular group of individuals who are to be invited and which has been generated based on the individual user profiles and possibly additional information.

Users are typically interested in scheduling a social event in any of three ways. In a first approach, the user may begin with a fixed group of people (e.g., family, circle, team, etc) who he or she would like to invite to an activity. The user wishes to obtain recommendations for one or more activities in which the fixed set of invitees may be interested in participating. Alternatively, in a second approach the user may begin with one or more activities and wishes to obtain recommendations for invitees who are to be invited to participate in those activities. In a third approach the user wishes to obtain recommendations for both the group of invitees and the activities in which those invitees are to participate.

In one implementation, the recommendation engine 155 operates in any of the three modes that reflect the different approaches the user may wish to take in planning a social event. The user can select from among any of the three modes and may even start with one mode and switch to another. Moreover, after obtaining a recommendation(s) in any of the modes, the user may incrementally add or remove activities and/or invitees, after which the recommendation engine 155 can update its recommendations based on the user's changes.

In the first user-selectable mode the recommendation engine provides at least one recommendation. Each recommendation generally includes two or more invitees and at least one activity to be attended by the invitees. The invitees may be selected from those individuals associated with the user's social network, a subset thereof which may be designated by the user, or some other group of individuals designated by the user. In this first mode neither the activities nor the invitees are selected in advance by the user. That is, neither the activities nor the invitees are fixed (i.e., predetermined) before receiving one or more recommendations. When requesting a recommendation, the user may or may not specify any constraints. (e.g., date, timeframe, geographic location, weather) that are to to be imposed on the social event.

In the second user-selectable mode the recommendation engine 155 provides at least one recommendation in which the invitees are selected or fixed in advance by the user. In this case the recommendation engine 155 selects activities that those invitees may wish to participate in. In the third user-selectable mode the recommendation engine 155 provides at least one recommendation in which the activity or activities in which the invitees are to participate is fixed in advance. The recommendation engine 105 then selects invitees who may wish to participate in those activities.

Referring again to FIG. 3, the user interface 160 allows users to schedule, manage and coordinate their social events using the other modules and databases discussed above. Among other things, the user interface 160 allows users to post events, sign up other users, fill out user profiles and learn more about friends and their friends' friends. The user interface 160 communicates with the front-end interface 115 and may be realized in a browser, application or the like.

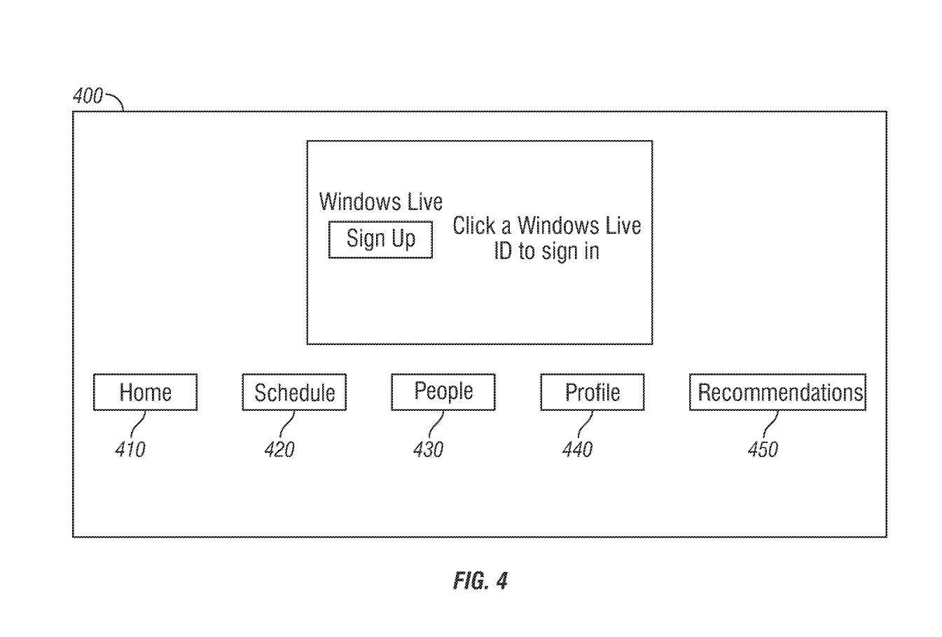

FIG. 4 shows one example of a screen shot of a web page that may be presented to a user through the user interface. The application or web page will generally be presented after the user has logged in to the system through a system administrator's web site. In this example the system administrator's web site is the Windows Live® web site operated by Microsoft. By logging in, users may add, delete and edit their own account information and establish a personal profile while controlling who else may access such information, schedule social events and so on. Examples of some of these capabilities will be presented below. Of course, these examples are merely simplified representative examples and do reflect the full capabilities of the event recommendation system discussed herein.

The screen shot 400 shown in FIG. 4 presents a menu bar that includes a series of navigation tags 410, 420 430, 440 and 450. Selection of the navigation tags may bring up items such as a schedule view, a people view, a profile view and a recommendations view. The schedule view provides a list of events that the user has scheduled, is in the process of scheduling or has received an invitation to attend. The events may be presented in a fashion similar to a calendar application. The events may be presented in a user-defined order and filtered using parameters such as time, location, and so on.

If the user selects the people tag 430 in FIG. 4 a list of people in the user's social network will be provided. The user may also be able to search for individuals that meet criteria of interest to the user. This may be accomplished by searching the profiles of the users. The user may also be provided with a link to the individuals that have been identified in order to send messages or otherwise establish communication with them by any appropriate means. The individuals, in turn, may be able to provide feedback on events that are being organized. The user may be able to refine the event parameters based on the feedback that is received.

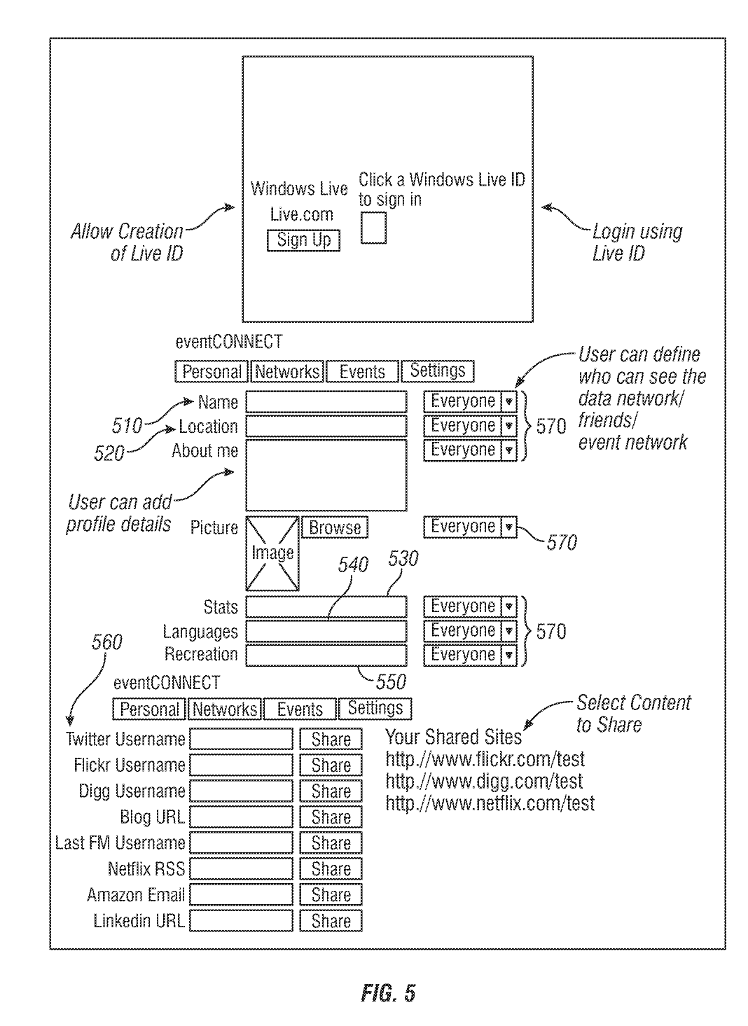

If the user selects the profile navigation tag 440 shown in FIG. 4, a web page may be presented that allows the user to establish and edit his or her own personal profile. An example of a screen shot of such a web page is shown in FIG. 5. The user constructs his or her personal profile by populating various fields 510, 520, 530, 540, 550 and 560. For instance, in addition to such basic information as name, contact addresses, and the like, other fields may allow the attendee to specify professional, recreational, cultural and other interests, languages spoken, special skills and so on. In addition, the attendee may enter one or more usernames that he or she uses on various social networking sites. Each username provides a link to the attendee's profile on a different social networking site. Examples of such sites include, without limitation, Facebook, Twitter, Flickr, Digg, Netflix, Amazon and Linkedin. By providing these usernames the user can share with other individuals additional information about him or herself that is available on the social networking sites. Such additional information may include friends and other individuals for which the user has provided links. In this way these friends and individuals may become a part of the network of individuals who can be searched and identified by the recommendation engine 155 and who may be invited to upcoming social events that are to be scheduled.

Each field in the attendee's profile may be shared with all other users or only with various subsets of users by appropriate selection from a pull-down menu 570 associated with the various fields.

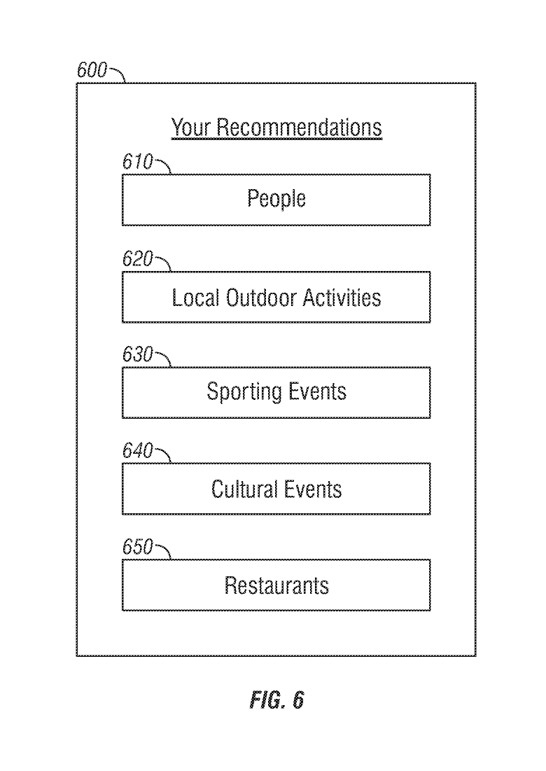

Once the user's profile is complete the data contained therein (including data contained in the users' social networking profile(s)) may serve as metadata or tags that can be searched by other users and the recommendation engine 155 to make various recommendations of events and activities that may be of interest to the user. For instance, as shown in FIG. 6, by clicking on the recommendations tag 150 in FIG. 4 the user may select from among a variety of categories on a recommendations page 600. In this example the categories include people (e.g., other users) 610, local outdoor activities 620, sporting events 630, cultural events (e.g., museums, theaters) 640 and restaurants 650. By selecting one of the categories the user may request recommendations using any of the three modes of operation discussed above. In addition, or instead of organizing the recommendations by category, the order in which the recommendations are presented may differ from that shown in FIG. 6 and may be presented, for instance, in a global or cross-category manner.

### Example

The following description presents one example of an algorithm that may be used by the recommendation engine 155 to schedule social events. Of course, this example is presented by way of illustration only and, more generally, a wide variety of different algorithms may be employed.

Basic Terms and Symbols:
Let Ube the set of all users, that is, U is the User Space
Let E be the set of entity/activity space: that is, E is the Entity/Activity Space
Let C be the space of contexts (location, time, etc.)
Let c be context from C
Let u be a subset of U
Let e be a subset of E
Let H be a function space of utility functions of U and E: U×E×F [symbol] R (Space of Real Numbers)
Let h be a utility function from H
Let a designate a specific user or an organizer (who creates the recommendation but doesn't participate); a is called an actor below

In the following, the subset u includes a if a is a participant or excludes a if a is only an organizer. The three modes of operation can be modeled mathematically as follows:
1. First mode of operation: Given u, h and c, find a subset e such that the utility function h(u, e, c) is maximized
2. Second mode of operation: Given e, h, c, and an actor a, find a subset u such that the utility function h(u, e, c) is maximized
3. Third mode of operation:
   3.1. Given an actor a, a utility function h, and a context c, let u[0] be the initial group and e[0] be the initial entity-activity set (there are multiple of ways of initializing u[0] and e[0], for example, starting with the first or second mode of operation);
   3.2. Let i=0; loop
      3.2.1. Actor a creates u[i+1] from u[i] by adding or subtracting users from u[i] and find e[i+1] such that the utility function h(u[i+1], e[i+1], c) is maximized; or
      3.2.1.1. Actor a creates e[i+1] from e[i] by adding or subtracting activities from e[i] and find u[i+1] such that the utility function h(u[i+1], e[i+1], c) is maximized;
   3.2.2. If actor a is “satisfied” break out of the loop; else let i=i+1 and go to step 3.2.1.

### Utility Functions

Let u designate a specific user and e designate a specific entity/activity. Both u and e can be modeled as feature vectors. Without loss of generality, it can be assumed that users and entity/activities are mapped to the same Feature Vector Space, that is, u=<f₁, . . . , fₙ>, e=<g₁, . . . , gₙ>, where f₁, . . . , fₙ, and g₁, . . . , gₙ are specific values for the vector components of u and e, respectively.

Intuitively, a utility function h assigns a satisfactory score of an entity/activity e to a user u in the context of c. The higher the score, the higher the utility. That is, h({u}, {e₁}, c)≧h({u}, {e₂}, c) if e₁ is more desirable than e₂ to the user u.

For a set u of users and a set e of entities/activities, let u={f₁, . . . , fₙ}, e={g₁, . . . , gₙ}. The h(u, e, c) can be defined as some “normalized” measure of all pair-wise utility function h({fᵢ}, {gᵢ}, c), where 1≦i≦k and 1≦j≦m. The possible measures include average, median, minimum, maximum, variance, etc.

Of course, it is possible to define more complex utility functions such that the utility of e to a user c depends also on other users invited and entities/activities included. The above-described problem definitions can be solved using standard mathematical optimization techniques.

As used in this application, the terms “component,” “module,” “engine,” “system,” “apparatus,” “interface,” or the like are generally intended to refer to a computer-related entity, either hardware, a combination of hardware and software, software, or software in execution. For example, a component or the like may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved. The techniques and solutions described in this application can be used in various combinations to provide an improved user experience with mobile devices, including mobile devices such as smart phones.

Having described and illustrated the principles of our innovations in the detailed description and accompanying drawings, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

1. A system for recommending social events, comprising:
a front-end interface for establishing communication over a communications network;
a user database for accessing a plurality of user profiles;
an activities database for accessing a plurality of activities that users may attend;
a recommendation engine operable in at least a first user-selectable mode, the first user-selectable mode providing at least one recommendation, each of the recommendations including a plurality of invitees and at least one activity to be attended by the plurality of invitees, said plurality of invitees being selected from a set of invitees accessible through the user database module and the least at least one activity being selected from a set of activities accessible through the activities database module, the plurality of invitees and the least one activity being undetermined in advance.

2. The system of claim 1 in which the recommendation engine is operable in at least two user-selectable modes, the second user-selectable mode providing at least one recommendation in which either the plurality of invitees or the at least one activity is fixed in advance.

3. The system of claim 1 in which the recommendation engine is operable in at least three user-selectable modes, the second user-selectable mode providing at least one recommendation in which the plurality of invitees is fixed in advance, the third user-selectable mode providing at least one recommendation in which the at least one activity is fixed in advance.

4. The system of claim 3 in which the recommendation engine is operable to switch between any of the three user-selectable modes upon user request.

5. The system of claim 1 in which the recommendation engine is operable to generate the at least one recommendation based at least in part on the plurality of user profiles.

6. The system of claim 1 in which the user profile of at least one invitee in the set of invitees is available through the user's social network.

7. The system of claim 1 in which the recommendation engine is operable to generate the at least one recommendation based at least in part on a history of previously made activities in which the plurality of invitees participated.

8. The system of claim 1 in which the recommendation engine is operable to generate at least one revised recommendation based at least in part on feedback from at least one of the plurality of invitees included in the at least one recommendation.

9. A method for recommending a social event to a user, comprising:
receiving a request for at least one recommendation for a social event, the social event including at least one activity and a plurality of invitees selected from a set of invitees who belong to the user's social network;
generating the at least one recommendation in accordance with the request;
sending the at least one recommendation to the user over a communications network;
receiving a revised request adding or removing from the at least one recommendation at least one of the plurality of invitees or the at least one activity;
responsive to the revised request, generating at least one revised recommendation revised in accordance with the revised request; and
sending the revised request to the user over the communications network.

10. The method of claim 9 in which the request further includes at least one activity and/or at least one invitee to be included in the at least one recommendation for the social event.

11. The method of claim 9 in which the request further includes one or more constraints to be imposed on the social event.

12. The method of claim 9 further comprising generating the at least one recommendation based at least in part on a profile of each invitee in the set of invitees.

13. The method of claim 12 in which the profile of at least one invitee in the set of invitees is available through the user's social network.

14. The method of claim 9 further comprising generating the at least one recommendation based at least in part on a history of previously made activities in which the plurality of invitees participated.

15. The method of claim 9 further comprising generating the at least one recommendation based at least in part on a profile of a group of invitees defined by a subset of the set of invitees.

16. The method of claim 9 further comprising generating the at least one revised recommendation based at least in part on feedback from at least one of the plurality of invitees included in the at least one recommendation.

17. One or more computer-readable storage media containing instructions which, when executed by one or more processors, perform a method comprising:
receiving a request from a user to provide at least one recommendation for a social event, the social event including at least one activity and a plurality of invitees selected from a set of users who belong to a social network associated with the user, the request specifying neither the plurality of invitees nor the at least one activity;
generating the at least one recommendation in accordance with the request; and
sending the at least one recommendation to the user over a communications network.

18. The computer-readable storage media of claim 17 in which generating the at least one recommendation includes optimizing a utility function that depends on a space of the set of users, a space of all activities, and a space of contexts defining when and where the social event is to take place.

19. The computer-readable storage media of claim 18 receiving a revised request adding or removing from the at least one recommendation at least one of the plurality of invitees or the at least one activity;
responsive to the revised request, generating at least one revised recommendation revised in accordance with the revised request; and
sending the revised request to the user over the communications network.

20. The computer-readable storage media of claim 19 further comprising recording feedback from previously attended social events, wherein generating the at least one recommendation in accordance with the request includes using the feedback to generate the at least one recommendation.
